(19) United States
(12) Patent Application Publication
(10) Pub. No.: US 2010/0223823 A1
(43) Pub. Date: Sep. 9, 2010

(54) DEVICE FOR LABELLING

(75) Inventor: David John Gordon, Woolloomooloo, NSW (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Bedrobe Pty Ltd., Woolloomooloo (AU)

(21) Appl. No.: 12/713,682

(22) Filed: Feb. 26, 2010

(30) Foreign Application Priority Data
Mar. 2, 2009 (AU) 2009900907

(51) Int. Cl. G09F 3/10; G09F 3/02

(52) U.S. Cl. 40/316; 40/672; 40/638; 40/6

(57) ABSTRACT

A device (1) for labelling an item (5), the device (1) including a first portion (15), and second portion (10, the second portion (10) being attached to the first portion (15), where the first portion (15) and the second portion (10) are moveable to a folded position, such that at least a portion of the item (5) is enclosed between the first portion (15) and the second portion (10), in the folded position.

### FIELD OF THE INVENTION

The present invention relates to a device for labelling, and in particular, a device for labelling a portion of an item, such as a cable, a carabiner, a bag, or a carry strap or the like.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

According to one example, it will be appreciated that cables, such as charger cables, power cords and to some extent data transfer cables are generally supplied (i.e. included in the sale) as a component to/with portable devices such as cameras, mobile phones and GPS navigators, computer peripherals and electronic equipment such as monitors, printers, routers, TV's and DVD players, or the like. Generally, these cables do not identify the specific device that they are made to fit.

Furthermore, cables are typically manufactured in black, or grey, and thus cables which are the same colour and similar shape can be difficult to distinguish amongst multiple cables that are commonly found in the home, car or office—thus making it difficult to identify cables once they are pulled out from the particular device they belong to. As it is common for households, cars and offices to have multiple portable devices, computer peripherals and other electronic equipment, with similar looking cables, it can be confusing, inconvenient, and time consuming to try to identify the correct cable that fits each particular device.

Additionally, it will be appreciated that it is important that the correct cable is used to power a particular device. Use of the wrong cable can result in permanent damage to the device it is powering, due to the incorrect voltage and/or amperage from the wrong cable being used, or due to the incompatible ‘male’ connection on the cable damaging the corresponding ‘female’ connection on the device, when attempting to plug the wrong cable into the device.

According to yet a further example, bags such as camera bags, portable device bags, cases, and electronic accessory bags which are usually sold separately as an accessory for a particular portable device (such as cameras, mobile phones, GPS Navigator systems, etc.), may suit multiple portable devices and electronic accessories.

Thus, these bags are generally made without any identification on the outside of the bag that specifies the particular device or accessories that the bag is designed to hold. In particular, any identification (if at all) on the outside of these bags is usually limited to the name and/or logo of the manufacturer of the device or accessories that the bag is designed to hold.

However, as manufacturers often produce a wide range of portable or electronic devices and accessories, the manufacturers' names and/or logos may not necessarily identify the particular device or accessories that may be stored in each bag. As it is common for households to have multiple portable and electronic devices and accessories in the home or car, stored in various bags and cases, it is often necessary to physically open each bag to identify the particular contents of the bag. This is both time-consuming and inconvenient, particularly when one member of the household may want to locate a particular device or accessory amongst many similar devices or accessories owned by themselves or other family members.

It will also be appreciated that other items such as bags, carry straps or the like can face similar issues to cables.

The present invention seeks to substantially overcome, or at least ameliorate, one or more disadvantages of existing arrangements and/or provide an alternative to existing arrangements.

### SUMMARY OF THE PRESENT INVENTION

According to a first broad form, there is provided a device for labelling an item.

According to a second broad form, there is provided a device for labelling an item, the device including a first portion, and a second portion, the second portion being attached to the first portion, wherein the first portion and the second portion are moveable to a folded position, such that at least a portion of the item is enclosed between the first portion and the second portion, in the folded position.

According to one example, a surface of the first portion and a surface of the second portion are attached to each other in the folded position.

In yet a further example, the first portion has an attaching member, the attaching member being configured to attach to the second portion, when in the folded position, to form a second folded position.

According to another aspect, the first portion has a first neck and a first head, the first head being attached to the first neck at one end of the first neck, the first neck being attached to a second neck of the second portion at the other end, the second portion having a second head attached to the second neck, where in the folded position, the first neck and the first head are substantially aligned with the second neck and the second head respectively.

In yet a further form, the first head is attached to the first neck at one end and to an attaching member at the other end, such that, when in the folded position, the attaching member is configured to be foldable over the second head.

In another example, the attaching member adheres to the second head.

According to a further example, the attaching member is substantially the same shape as the first and second heads.

In a further form, the device has an adhesive surface, such that when in the folded position, the first and second portions adhere together and/or encapsulate at least a portion of the item placed between them.

According to another example, the second head is a panel including instructions printed thereon for a user of the device, such that when the attaching member folds over the second head, the instructions are at least partially concealed.

In yet another form, any one or a combination of the first head, the first neck, the second head, and the second neck are panels which are able to receive information.

According to a further aspect, the information includes any one or a combination of a user's details, and item details.

In another form, the device is available in a variety of colours, each colour being associated with a user of the item or associated with additional identification details of the item.

In another example, the item includes an elongate portion, the elongate portion being at least partially enclosed between the first and second portions of the device.

According to another form, the item is any one or a combination of a cable, a carabiner, a carry strap, a bag handle and/or a shoulder strap.

In a further example, the device includes at least one fold line.

According to one particular example, the device has an adhesive surface, such that when in a folded position, the first and second portions adhere together and/or encapsulate the item placed between them.

It will be appreciated that the broad forms of the invention may be used individually or in combination.

### BRIEF DESCRIPTION OF THE DRAWINGS

An example of the present invention will now be described with reference to the accompanying drawings, in which:—

FIG. 1 is a schematic diagram of a plan view of an example of a device for labelling;

FIG. 2A is a schematic diagram of a plan view of the example device of FIG. 1, in its unfolded position;

FIG. 2B is a schematic diagram of a plan view of the device of FIG. 2A, in its first folded position;

FIG. 2C is a schematic diagram of a plan view of one side of the device of FIG. 2A, in its second folded position;

FIG. 2D is a schematic diagram of a plan view of the other side of the device of FIG. 2A, in its second folded position;

FIG. 3A is a schematic diagram of a plan view of another example device for labelling;

FIG. 3B is a schematic diagram of a plan view of another side of the example device of FIG. 3A;

FIG. 3C is a schematic diagram of a plan view of another example device for labelling; and,

FIG. 3D is schematic diagram of a plan view of another side of the example device of FIG. 3C.

### MODES FOR CARRYING OUT THE INVENTION

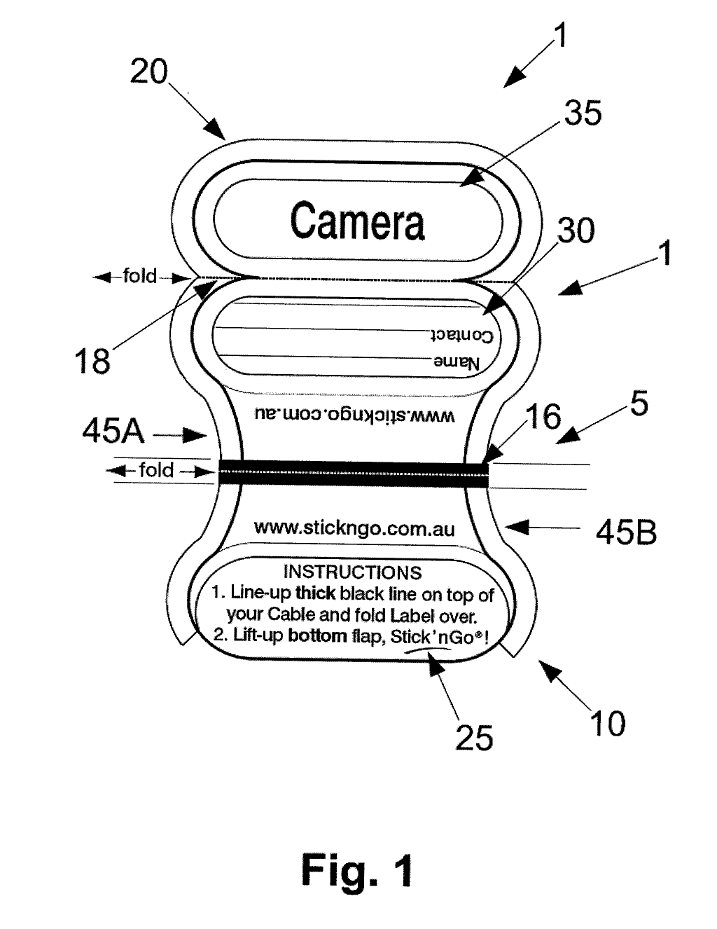

An example of a device 1 for labelling is shown in FIG. 1.

In particular, FIG. 1 shows the device 1 for labelling an item 5. The device 1, in this example, includes a first portion 15 and a second portion 10, the second portion 10 being attached to the first portion 15 (which, in this example is at a fold line 16). Thus, in this particular example, either the first portion 15 or the second portion 10 (or both) are moveable to a folded position such that at least a portion of the item 5 is enclosed between the first portion 15 and the second portion 10, in the folded position.

Accordingly, in one particular example, the first and second portions 15, 10 can be attached to each other when the device 1 is in the folded position. It will be appreciated that this can occur in a variety of ways, some of which are further discussed below, however, according to one example, a surface of the first portion and a surface of the second portion may be attached together.

Thus, the first portion 15 can include a first neck 45A and a first head 30, the first head 30 being attached to or extending from the first neck 45A at one end of the first neck 45A. In this particular example, the first neck 45A is attached to a second neck 45B of the second portion 10 at the other end of the first neck 45A. The second portion 10 has a second head 25, which is attached to the second neck 45B. Thus, when in the folded position, the first neck 45A and the first head 30 are substantially aligned with the second neck 45B and the second head 25, respectively.

The example in FIG. 1 also shows that the first portion 15 includes an attaching member 20, where the attaching member 20 is configured to attach to the second portion 10, when the device 1 is in the folded position. Thus, for example, the first head 30 can be attached to or extends from the first neck 45A at one end and to the attaching member 20 at the other end, such that, when in the folded position, the attaching member 20 is configured to fold over the second head 25, which can be referred to as the second (or completed) folded position.

Accordingly, the attaching member 20 can adhere to the second head 25. Furthermore, as shown in FIG. 1, the attaching member 20 can be substantially the same shape as the first and second heads 30, 25, such that it is aligned with the first and second heads when in the second folded position.

It will be appreciated that the device 1 can include an adhesive surface such that when in the folded position, the first and second portions 15, 10, adhere together (either completely, substantially or partially) and/or encapsulate at least a portion of the item placed between them.

Thus, FIG. 1 also shows that the device 1 can include fold lines 16 and 18 for guiding a user to fold the device at least partially over an item 5, in order to label the item 5. The device can then be attached to the item 5 via the folding action and/or via adhesive surfaces of the heads 25, 30. Accordingly, the device 1 can be formed such that the first and second portions 15, 10 at least partially adhere together, or alternatively adhere to respective sides of the item 5 (depending on the width of the item 5). Additionally, the attaching member 20 can also be formed to adhere to the second portion 10, when folded over the second portion 10.

Additionally, the second head 25 can be or include a panel which can include instructions printed thereon for a user of the device 1, such that when the attaching member 20 folds over the second head 25, the instructions are at least partially concealed (when in the second or completed folded position). Furthermore, any one or a combination of the first head 30, the first neck 45A, the second head 25, and the second neck 45B, can include panels which are able to receive information such as, for example, a user's details (such as name, address or the like), and item details (such as type of item, description of use, or the like). In this particular example, the panel 35 includes the word “camera”, which is displayed on the label, in order to identify that it is a camera, or camera accessory (such as a camera cord or cable) which is being labelled.

Notably, the item itself can include an elongate portion, where the elongate portion of the item is at least partially enclosed between the first and second portion 15, 10 of the device 1. Thus for example, the item can be any one or a combination of a cable, a carabiner, a carry strap, a bag handle, a shoulder strap, or the like.

Thus, it will be appreciated by persons skilled in the art that the third panel 35 can display numerous different item types, such as, and not limited to mobile phones. MP3 players and other music players (including CD players, tape players, etc.), navigator devices, game consoles, game controls, DVD, HDD, Hi-Fi, or video players, camera devices (including video and still cameras). TV, VCR, Pay TV devices, Set Top boxes, computer devices and peripherals (such as keyboards, monitors, mouse, hard drives, DVD drives, modems, routers, network or server cables, laptops), photocopiers, facsimile machines, scanners, printers, multi-function devices, shredders, power boards, or the like.

It will also be appreciated that the device 1 can be available in a variety of colours, each colour being associated with a use of the item or associated with additional identification of the item.

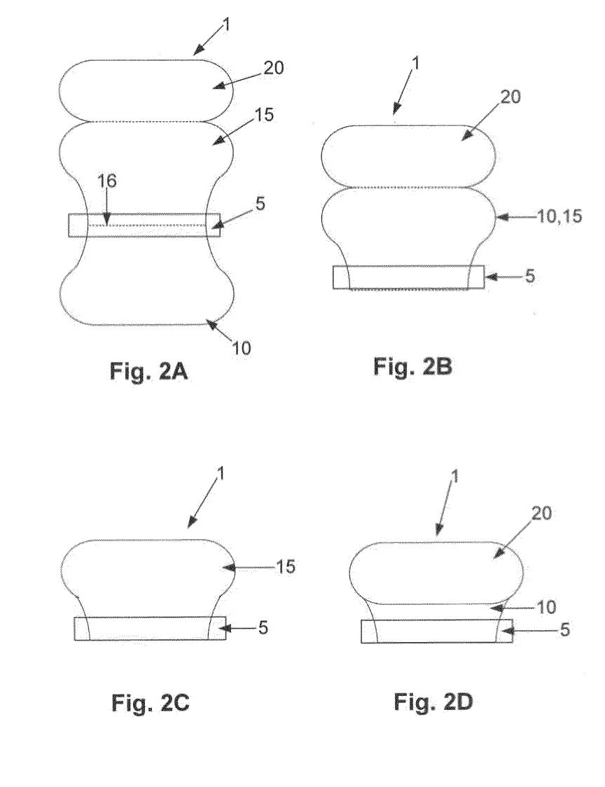

FIGS. 2A to 2D show the device 1 in its variety of folded positions. In particular, FIG. 2A shows an example of the device 1 in its unfolded position, where the item 5 is placed in the fold position at the first end 16. FIG. 2B shows the device 1 in a first folded position where the first portion 15 and second portion 10 are folded together. Thus, the first folded position may encase the item 5 at least partially between the first and second portions 15, 10.

FIGS. 2C and 2D show an example of the third portion or attaching member 20 being folded over the second portion 10, such that the attaching member 20 at least partially covers the second portion 10. Thus, the label device 1 is now attached to the item 5.

As can be seen in FIGS. 1 and 2A, the device 1 can be shaped such that the second portion 10 and the first portion 15 mirror each other in their shape. It will be appreciated that this can allow for the first and second portions 15, 10 to be aligned correctly when folded together. Furthermore, as shown in FIGS. 1 to 2D, the first and second portions 15, 10 generally include a bulbous or head portion 25 30 at one end, and a narrowing (or neck) portion 45A, 45B, which attaches to a respective narrowing portion 45A, 45B of the other portions 10. 15. As further described below, the bulbous portions/heads can be used to provide information to or receive information from a user of the device 1, and the narrowing portions 45 (which in this example have grooved sides, or recessed portions), can be used to receive and/or encase items of varying sizes.

Thus, the above described device for labelling can be used to label a variety of items including, but not limited to portable devices, electronic device cables, network server cables, patch panel cables, computer peripherals and accessories, keys, home entertainment equipment, camera bags, cases, and electronic accessory bags and any item with a carry strap or shoulder strap attached to the item.

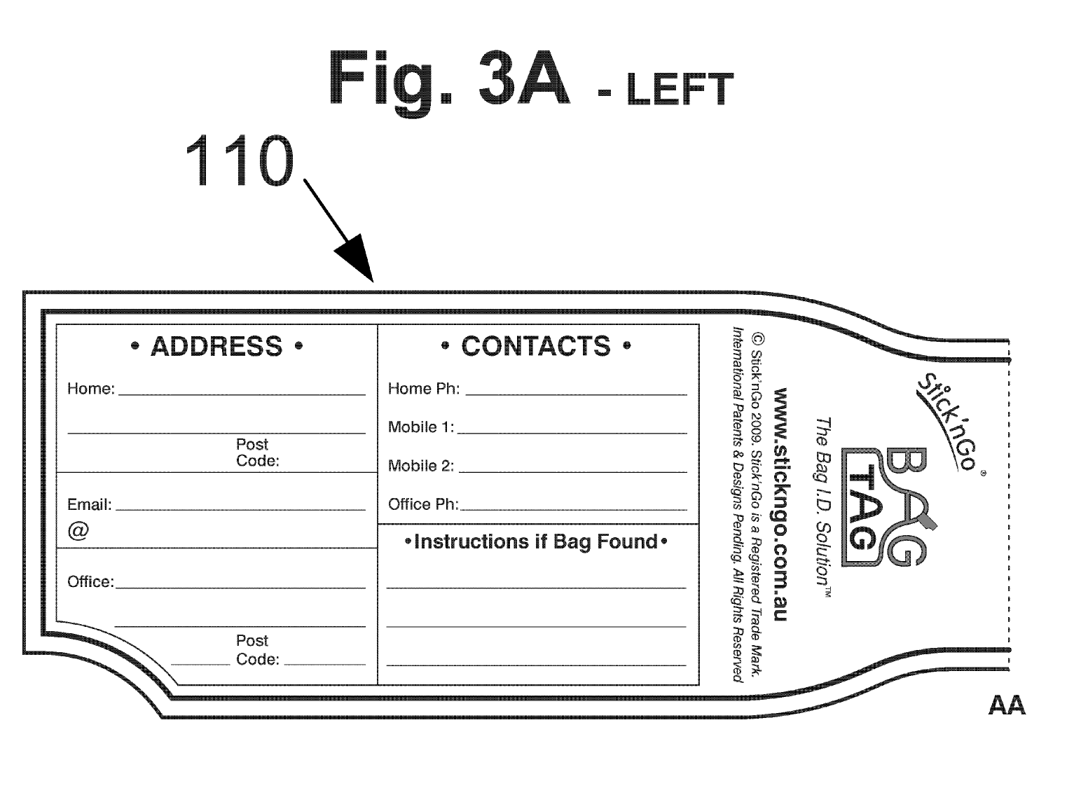

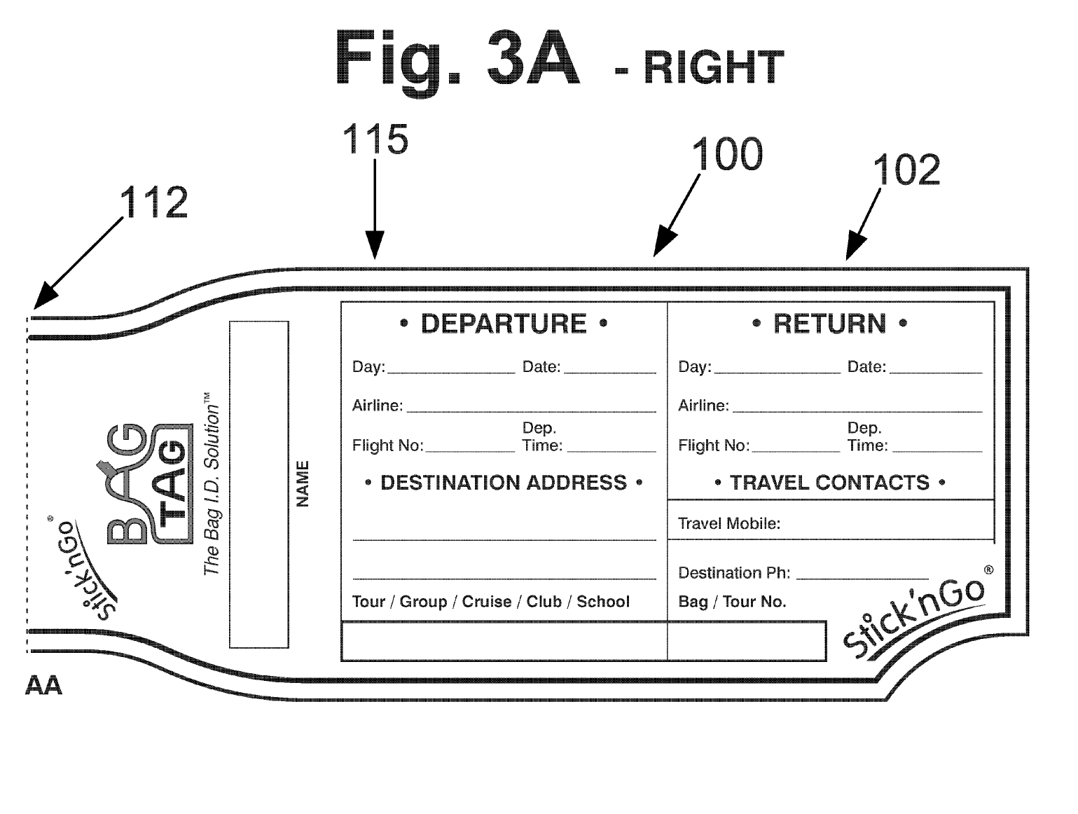

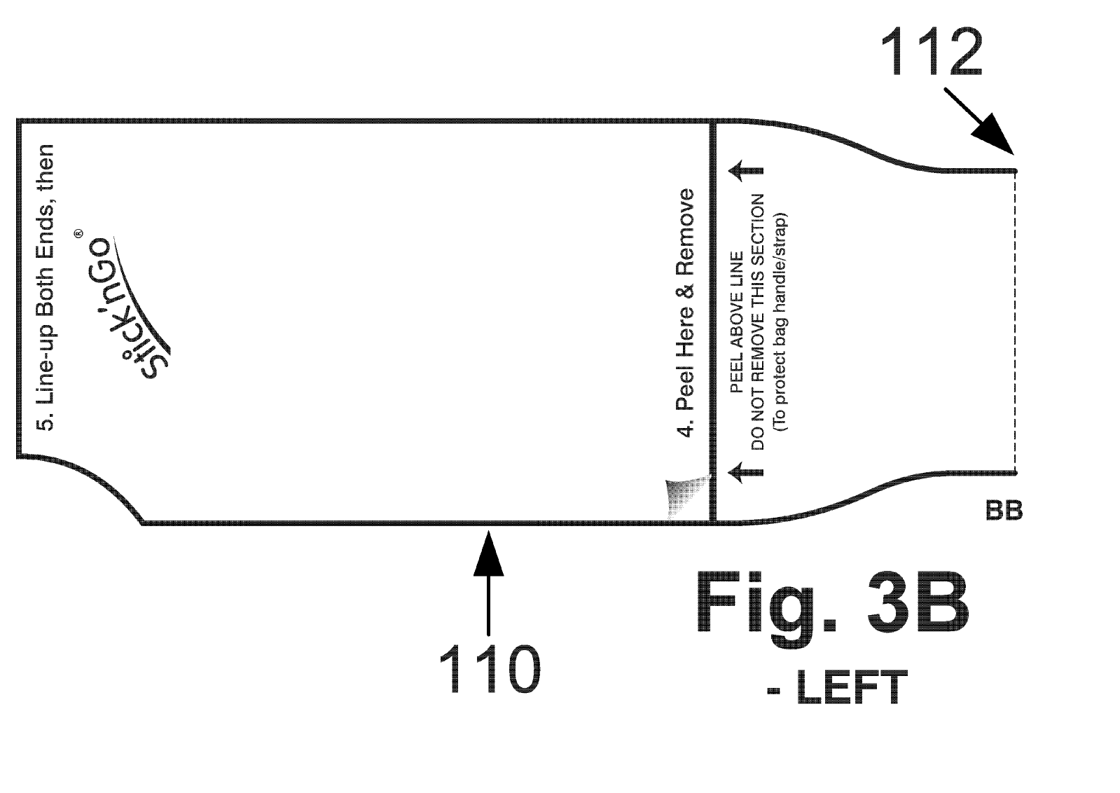

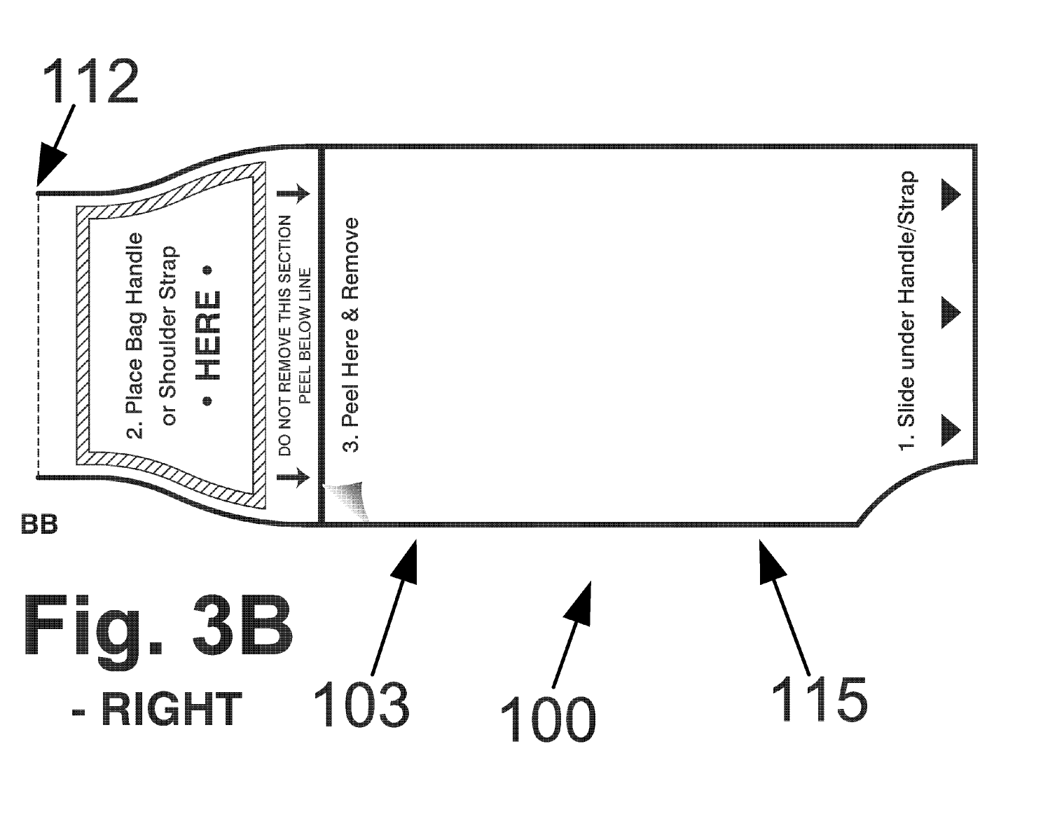

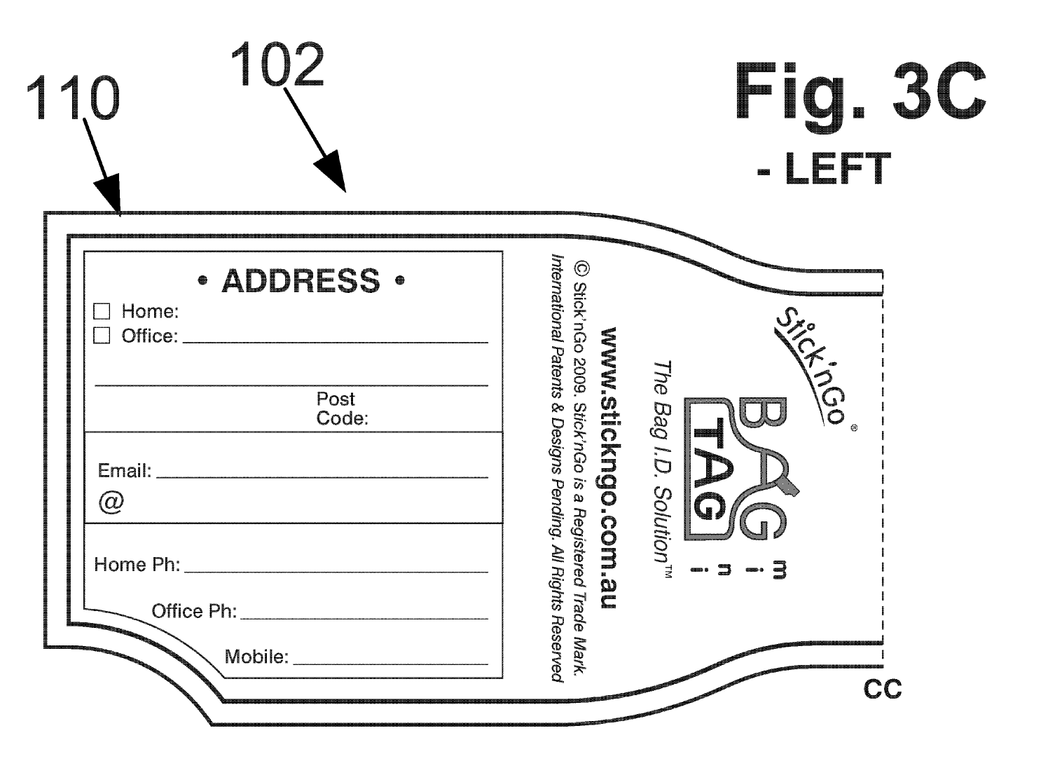

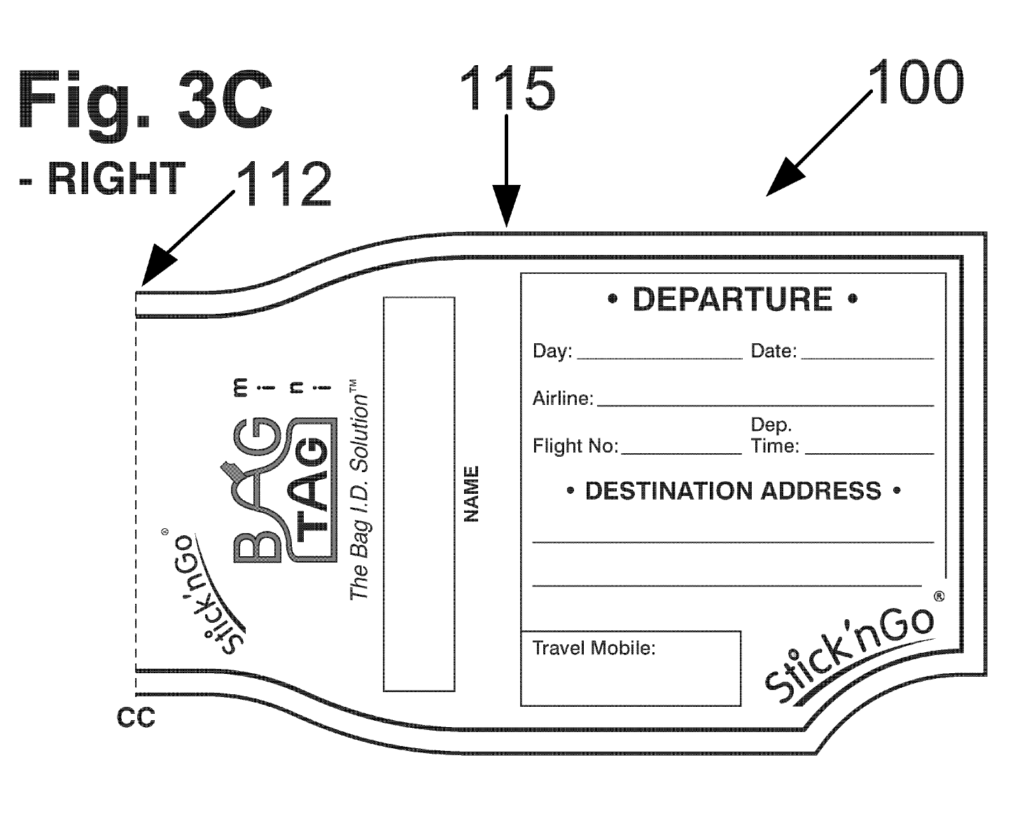

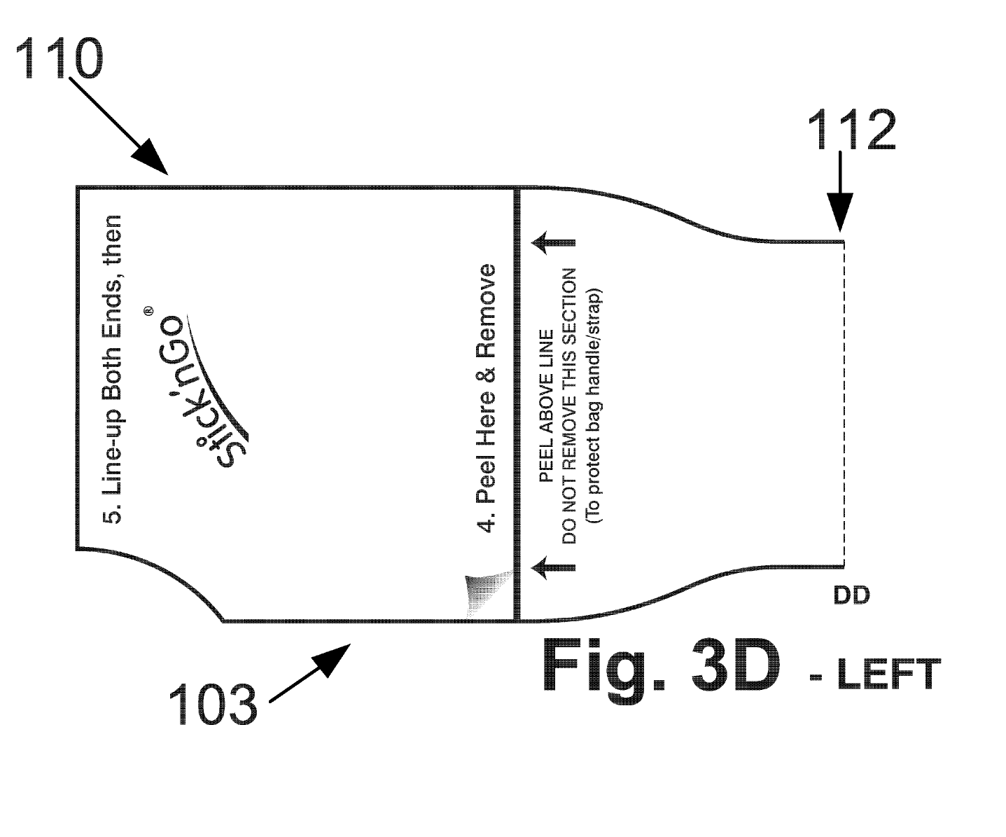

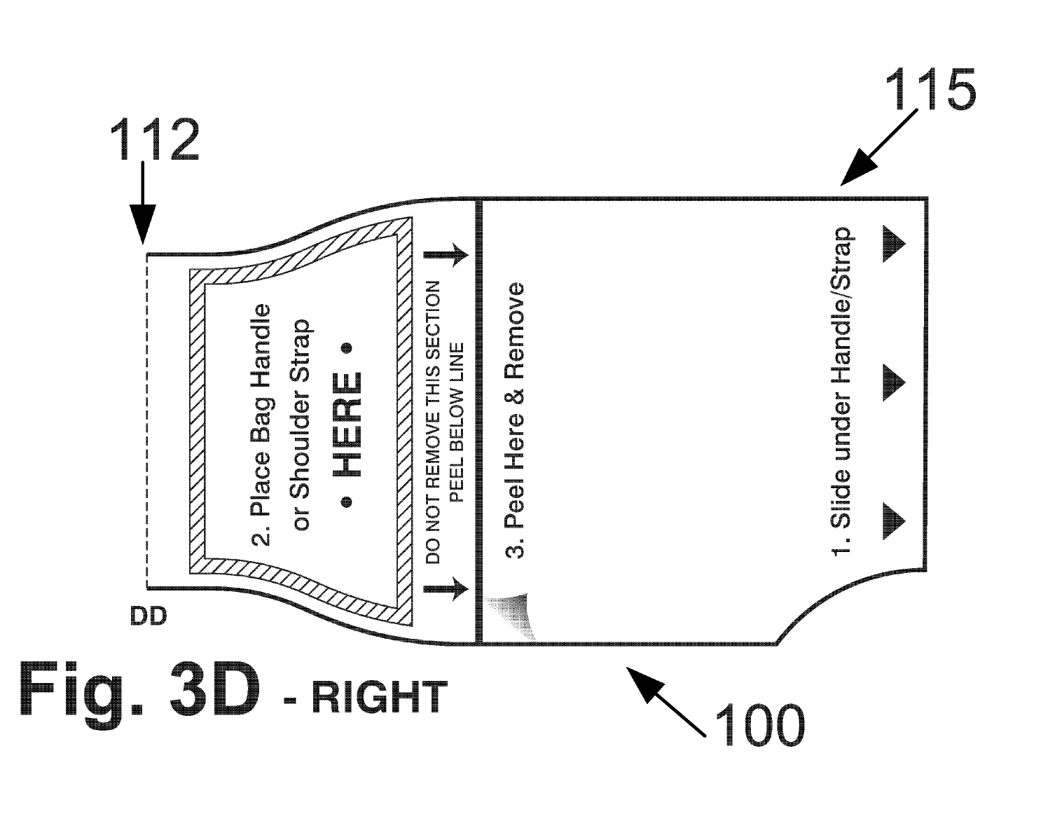

FIGS. 3A to 3D show another example of a device for labelling.

In particular. FIGS. 3A to 3D show a device 100, which in this particular example can be used to label bags for travelling purposes. Typically, the device 100 has a first surface 102 (shown in FIG. 3A) and a second surface 103 (shown in FIG. 38). The device also has two arms 110 and 115, which can be joined together at a fold 112.

In this particular example, the first surface 102 is able to receive information in respect of the user. As shown in FIG. 3A, the first surface 102 can receive information in respect of a user's address and contact details, as well as flight information, such as departure and return details, destination address, travel contacts, and instructions to the finder (of a lost bag). It will be appreciated that if baggage is lost whilst travelling, then information such as the destination address (instead of the home address of the user) and instructions to the finder can help in returning baggage to the user during a trip. Accordingly, a user of the device 100 may not have to wait to return home in order to be able to use their belongings.

In yet another example, the first surface 102 is also able to receive medical or emergency information (such as the user's blood type, medical conditions and allergies) in respect of the user in addition to the user's address, contact details, flight information, destination address and travel contacts. It will he appreciated that if the user suffers from an accident or medical emergency whilst travelling, then the user's medical information may be helpful to any person providing assistance to the user.

It will be further appreciated that the medical or emergency information may be particularly useful to people rendering medical assistance to the user, should the user suffer from allergies or medical conditions such as a heart condition or diabetes. The medical or emergency information may also be particularly useful if the user is a young child travelling without a guardian, or an elderly person travelling alone (as commonly occurs). Such medical or emergency information recorded on the device may provide a level of comfort and reassurance to the user, and/or to the user's relatives, friends and colleagues not travelling with the user.

Notably, the device 100 shown in FIGS. 3C and 3D is a variation of the device 100 of FIGS. 3A and 3B and is not as elongate as the device shown in FIGS. 3A and 3B, and thus may not be able to receive as much information as the device of FIGS. 3A and 3B. However, it will be appreciated that the device 100 shown in FIGS. 3C and 3D may be less obtrusive on smaller bags such as lap-top bags, briefcases and carry-on (cabin) luggage.

In the examples shown in FIGS. 3A to 3D, the surface 103 of the device 100 includes an adhesive element such that the arms 110 and 115 can be folded at the fold 112 to meet each other at the surface 103, and such that the arms 110 and 115 adhere together. According to one particular example, it will be appreciated that the section between the arms 110 and 115 may not necessarily adhere completely together and only a portion of the arms 110 and 115 may adhere together.

In this particular example, the adhesive is exposed when a protective layer is peeled and removed from at least a portion of the surface 103 (leaving another portion of the surface 103 with the protective layer still attached to the device, so as to protect the bag handle or shoulder strap from coming into contact with the adhesive). Typically the handle portion or shoulder strap of a bag, suitcase, or the like, can be placed at or near the fold 112 such that the arms 110 and 115 encapsulate at least a portion of the handle or shoulder strap, and when the arms 110 and 115 are stuck together, the label then becomes attached to the handle of the bag or the shoulder strap of the bag.

Thus, the device for labelling as described herein can provide a durable label which is generally not prone to tear or is generally affected by minimal deterioration over time. In particular, as the device described herein undergoes several folding actions, it may be less prone to separating around the edges and coming apart due to moisture or weakening of the adhesive. Furthermore, the device described herein is slim-lined in design and easy to attach to cables or the like, as the device forms a flat, flexible surface against the cables. Thus, when cables are wrapped up for storage or for travelling, the device described herein is minimally obtrusive.

It will also be appreciated that the device described herein typically does not easily detach from the cables, which can be advantageous when the cables are wrapped-up and placed into bags for travelling, often with no protection around them.

Additionally, the device described herein includes a personal identification area which is specifically designed for the user or owner of the device to record (or write) their identification details on the device, such as the owner's name and contact details or location details of the item.

The device when in use with a bag can allow for identification of the bag without the need for manufacturers of bags to include a bag label. Furthermore, when used with a bag, the device described herein is able to remain attached to the bag for a greater period of time and is less susceptible to deterioration or tear after a short period of use.

It will be appreciated that many camera bags, portable device bags and electronic accessory bags look similar in colour, style and/or design. In the home or car, with more than one family member, it is often necessary to open each bag or case to identify the particular device or accessories being stored and/or to identify which family member owns the particular device or accessories. This process can be both time-consuming and inconvenient.

Furthermore, camera bags, portable device bags and electronic accessory bags generally only allow for personal identification (if at all) on a writable section inside the bag (usually on the underside of the bag ‘lid’), necessitating the need to open the bag to find out who owns the bag.

Without more obvious owner identification on the outside of the bag, this shortcoming could lead to lost bags not being returned quickly to their owners, if found.

Accordingly, the device described herein can provide numerous advantages (some of which are further described below). In one particular example, the device described herein can provide a triple identification mechanism, where the particular item that the cable is made to fit can be identified by the secure attachment of the device on the cable, the owner of the cable can be identified by providing the ability to record (for example, write) identification information (such as Name and contact details) onto the cable, and the owner of the cable can also be identified by associating the selected colour of the device with the owner.

The triple identification mechanism can also be provided in respect of other items. According to a further example, if using the device for labelling on a bag or the like, the bag can be identified as the bag which is for a particular object (such as a camera or the like), and the owner of the bag can also be identified in respect of the colour and the owner's information printed or written on the device.

It will also be appreciated that any of the features of the device as shown in FIG. 1 can be used in combination with the device as shown in FIGS. 3A to 3D.

Further examples with respect to various features of the device described herein are discussed below.

### Further Examples

According to one particular example, a device for labelling (also referred to herein as a “label”) can include a double-fold adhesive label printed on synthetic ‘paper’ (referred to herein as ‘film’), manufactured in a range of colours. The label is designed to be attached to any one or a combination of portable device, electronic equipment and computer peripheral charger cords, network server cables, patch panel cables, power cables and data transfer cables (referred to herein as ‘cables’), to carabiners, to the handles of suitable camera bags, portable device bags and electronic accessories bags, and further to the carry straps and shoulder straps of portable devices, or the like. The label is typically removed from a waxed backing paper (thereby exposing the adhesive on the back of the label) and folded over and stuck to the cable or carabiner or bag handle or carry strap in two ‘fold and stick’ actions, the last of which can fully encapsulate (or be wrapped around) the cable, carabiner, bag handle or carry strap. Accordingly, this can create a label that is triple the thickness and strength of the label film, in the lower half of the label.

In this particular example, one section of the label carries attachment instructions for the user, which is subsequently covered over, in the process of completing the second ‘fold and stick’ action. Once attached to a cable or carabiner or bag handle or carry strap or the like, one side of the label identifies the particular device that the cable fits, or identifies the items attached to the carabiner, or identifies the particular device or accessories that the bag contains or, for example, the specifications of the particular device to which the carry strap is attached (e.g. 10 Megapixel Camera with 3 Times Optical Zoom Lens). This is achieved by pre-printing or writing various device names on ‘sheets’ or ‘rolls’ of labels, covering a wide range of devices such as ‘camera’, ‘mobile phone’, ‘MP3 player’, ‘,GPS navigator’ etc. The other side of the label has a writable section that allows the user or owner to record personal identification information such as their Name, Mobile Phone Number and/or Email Address details or additional information on the use or location of the item. The label colour also instantly identifies the owner amongst family members, or amongst work colleagues as each family member or work colleague can select ‘sheets’ or ‘rolls’ of labels (covering numerous portable device, electronic equipment & computer peripheral product names) in their choice of colour.

Notably according to another particular example, the label can be attached to a carabiner and then clipped onto a key ring, whereby the label identifies the use of the key or keys on the key ring, such as ‘front door’, ‘back door’, ‘car’, ‘garage’, ‘shed’, ‘boat’, holiday home etc.

Some of the advantages that the device described herein can provide include, providing a label which is able to be attached to cables, carabiners, carry straps and suitable bag handles quickly, easily and securely, and is typically made from material which is durable, tear resistant and water resistant. Additionally, the label carries attachment instructions for the user, the instructions being conveniently covered over in the final stage of attaching the label to a cable or carabiner or carry strap or bag and the label (being relatively flat and flexible). Additionally, the label generally does not interfere with the operation of the cable or the function of the bag or the function of the item or items to which the carabiner or carry strap is attached.

Furthermore, according to another example, the label does not impede handling, wrapping and storage of cables, or handling and storage of carabiners, or handling and storage of bags, and the double-fold design of the label prevents the label from separating along the bottom edge and possibly being detached from the cable or carabiner or carry strap or bag handle over time. It will also be appreciated that the label clearly identifies the particular device that the cable is made to fit, or the particular device or accessories that the bag contains (without, for example, having to open the bag) or can provide other information about the device such as, for example, specifications of the device, to which a carabiner or carry strap is attached. The label can also instantly identify the owner of the cable or bag, or the owner of the device to which the carabiner or carry strap is attached, amongst family members or amongst work colleagues, by the selected colour of the label, or other information printed thereon.

Further still, the label clearly identifies the owner of the cable or the owner of the device to which the carabiner or carry strap is attached or the owner of the bag and its contents by the ability to record (i.e. write) personal information, such as a Name and Contact Details directly onto the label, using a standard ball-point pen. Users can also elect to write their details on the label using a fine-point permanent marker, thus making the personal identification indelible, smudge-proof and weather resistant. These benefits, which can be provided, can assist in the prevention of fraudulent alterations to the label, and makes the recorded information more durable, especially when travelling.

Accordingly, the label is made out of a synthetic ‘paper’ (film), which is strong, durable, flexible, tear resistant and water resistant, with a high-bond adhesive and quality feel. The label can quickly, easily and securely be attached to a cable, carabiner, carry strap, or bag handle and resists being detached or damaged under general use and storage of the cable, carabiner or bag.

Furthermore, the label can clearly identify cables for portable devices, network servers, patch panels, computer peripherals and home entertainment equipment, and the portable devices and computer accessories that the bags contain or the specifications or other information about the items or devices to which the carabiner or carry strap is attached. The colour of the label can also instantly identify the owner of the cable or bag or device amongst family members and amongst work colleagues or instantly identify additional details of the item such as location or use of the item.

The ability for the label to record personal identification details, provides a better chance of lost property being returned to the owner if found, as the identification is obvious on the cable label, the carabiner label, the carry strap label, and on the bag handle label (rather than written on the inside the bag). According to yet a further example, The process of the ‘double-fold and stick’ action (over a ‘single-fold and stick’ action) seals and binds the bottom edge of the label, thus preventing the top and middle label sections of the label from separating over time. The label is flexible and relatively flat, and therefore does not interfere with the use or storage of cables or other items to which it is attached, such as bags, handles, carry straps, or the like, or interfere with the ‘wrapping up’ of cables or packing of other items as described herein.

Thus, in this particular example, the device for labelling is a double-fold adhesive label printed on synthetic paper (referred to as ‘film’), manufactured in ‘sheets’ or ‘rolls’ (covering multiple device names) in a range of colours, that separates from a waxed backing sheet, and has a high-bond adhesive on the back of the label.

In this particular example, the label has a top section, a middle section and a bottom section in a specific shape. Notably, the top section has been referred to herein as the second portion 10, the middle section has been referred to as the first portion 15, and the bottom section has been referred to as the attaching member 20. Thus, the terms “top”, “middle”, and “bottom” are arbitrary terms used to define portions, which can be formed at various positions.

Accordingly, the label is designed to be attached to portable device, home entertainment and computer peripheral charger cords, network server cables, patch panel cables, power cables and data transfer cables (referred to herein as ‘cables’), to carabiners, to the handles of suitable camera bags, portable device bags and electronic accessories bags, and to the carry straps of portable devices or any other items to which carabiners and carry straps can be attached.

Notably, according to one particular example, the bag handle width, thickness and material is compatible with the label attachment process, so that the bag handle can be received by the device described herein.

As shown in the examples described herein, the middle and top sections of the label are placed on top of the cable, or edge of the bag handle or carry strap, or on to the rear bar of a carabiner, assisted by a thick black positioning fold-line printed on the label between these two sections. The top section of the label is then lined-up with the middle section of the label, assisted by the rounded shape of the left and right sides of each section of the label which allows the two label sections to be accurately lined-up, before bringing the two sections of the label (i.e. the top section and the middle section) together and sticking to the cable, carabiner, carry strap, shoulder strap, bag handle or the like.

Notably, according to another particular example, one part of the top section of the label and one part of the middle section of the label is specifically designed to accommodate (i.e. allow for) various cable, carabiner and carry strap circumferences, for example from 3 mm, up to 20 mm, and for various bag handle widths for example from 10 mm up to 25 mm, and for various bag handle thicknesses for example from 1 mm up to 3 mm. The cable, carabiner, carry strap or bag handle is therefore ‘sandwiched’ and stuck between the top and middle sections of the label, with the left and right sides of the label aligned. The bottom section of the label is then ‘flipped-up’ (again with the left and right sides aligned) and stuck over the top section of the label, thereby fully encapsulating the cable, carabiner, carry strap or bag handle, with the second ‘flip-up and stick’ action.

In this particular example, the label design has three features that can assist in the second ‘flip-up and stick’ action by the user being accurate. Firstly, there is a white dotted fold-line between the middle and bottom sections of the label, to indicate to the user where the bottom section of the label is folded. Secondly, the rounded shape of the left and right sides of the label (in each section) allows the user to line-up both the left and the right sides of the label before sticking the bottom section to the top section. Thirdly, there is a thin black guide-line on the top section (above the Instruction Panel) in the same shape as the top edge of the bottom section, thus giving a visual indication to the user, to guide them in sticking the bottom section hard up against this line, which also ensures the sides are aligned.

The above-described ‘double-fold and stick’ process creates a label that in the bottom half of the label is triple the thickness and strength of the label film. Importantly, the last process (i.e. the second ‘flip-up and stick’ action) also seals and binds the label along the bottom edge of the label, thus preventing the top and middle label sections from separating with use, and over time.

According to yet a further example, the top section of the label can carry instructions for the user. These instructions can be subsequently (and conveniently) covered over (at least partially) when the bottom section of the label is stuck over the top section of the label, in the process of completing the second ‘flip-up and stick’ action. The bottom section of the label (which is now effectively the front side of the label) identifies the particular device that the cable fits, or identifies the particular device or item, or specifications or other information of the device or item to which the carabiner or carry strap is attached or identifies the particular device or accessories that the hag contains.

This can be achieved by pre-printing or writing various device names on ‘sheets’ or ‘rolls’ of labels, covering a wide range of devices such as ‘camera’, ‘mobile phone’, ‘MP3 player’, ‘GPS navigator’, etc. The middle section of the label (which is now effectively the rear side of the label) has a writable section that allows the user or owner to record personal identification information such as their Name and Contact Details (e.g. Mobile Phone Number and/or Address or Email Address) or additional identification details of the item.

The user can also elect to write their details on the label using a fine-point permanent marker, thus making the personal information indelible, smudge-proof and weather resistant on the label film. These benefits assist in the prevention of fraudulent alterations to the personal information, and make the recorded information more durable, especially when travelling.

The label colour can also instantly identify the owner or user amongst family members, or amongst work colleagues or specific departments or locations, as each family member or work colleague can select ‘sheets’ or ‘rolls’ of labels, covering numerous devices, electronic equipment & computer peripheral product names, in their choice of colour. (e.g. grey colour labels for father, blue colour labels for mother, green colour labels for child No. 1 and pink colour labels for child No.2. Alternatively, grey colour labels for employee No. 1, blue colour labels for employee No. 2, etc. Or alternatively, grey colour labels for first floor ‘marketing department’, blue colour labels for second floor ‘sales department’ etc.)

Notably, the label design can also feature the label colour purposely ‘over-printed’ into the white Instruction Panel on the top section of the label. This over-printing compensates for any minor misalignment by the user when sticking the bottom section of the label over the top section of the label, and ensures a solid label colour is created after the bottom section is stuck over the top section of the label, even if the two sections have not been aligned perfectly.

Some features of the device for labelling as described herein are further described below:

### Feature: Two Positioning Fold-Lines and One Positioning Guide Line

According to one particular example, there are three lines printed on the label: (1) A fold-line (thick black line with a thin dotted white line inside it) printed on the label, between the top and middle sections of the label. (2) A fold-line (thin white dotted line) printed on the label, between the middle and bottom sections of the label. (3) A guide-line (thin solid black line) printed on the label, above the ‘Instruction’ panel on the top section of the label.

In this particular example, the first (thick black) fold-line is designed to be placed on top of a cable or on the rear bar of a carabiner or on the edge of a carry strap or on the top edge of a suitable bag handle, and can allow for the first fold over a cable, carabiner, carry strap, or bag handle to be accurate and not misaligned. This line also guides the user into placing the correct two sections of the label (i.e. the middle and bottom sections) over the cable, carabiner, carry strap or bag handle. The second (thin white dotted) fold-line ensures the bottom section of the label is aligned correctly when ‘flipped-up’ and stuck over the top section. The third (thin solid black) guide-line provides a visual indication to the user to stick the bottom section of the label hard up against this line, which also ensures the sides are aligned correctly.

Notably, the packaging of the labels can provide simple diagrams (line drawings) and clear instructions, which will allow most users to understand these features clearly.

It will be appreciated that the first positioning (thick black) fold-line can allow the user to correctly fold the label in the correct position when placing the label on top of the cable, carabiner, carry strap, or bag handle, and to align the sides of the label when they are brought together. Without the second fold line and the guide-line the user may not accurately align the bottom section of the label over the top section of the label.

Accordingly, after removal from the backing paper, the label is usually creased along the fold lines by the user (such instructions being typically shown on the label packaging), and placed over the cable, or carabiner or carry strap or bag handle, with the thick black fold-line placed directly on the centre of the cable (i.e. parallel with the cable), on the centre of the rear bar of the carabiner or on the edge of the carry strap, or on the top edge of the bag handle (parallel with the handle edge). Once the top and middle sections of the label have been brought together, the bottom section of the label is ‘flipped-up’ (assisted by the second crease) and placed over the top section of the label, with the solid black guide-line giving a visual indication of where the bottom section is placed.

Notably, it will be appreciated that these features are examples only and a single-fold label design without these features can be provided.

### Feature: Triple-Section Design and Double-Fold Operation

The triple-section design (top, middle and bottom sections) can allow for the double-fold operation, which is described herein. The double-fold operation seals and binds the label along the bottom edge, and creates a label which is triple the thickness of the original film in the bottom half of the label. Accordingly, the double-fold operation generally requires a triple-section label design, so that the features are used in conjunction with each other. The last action of ‘flipping-up’ the bottom section and sticking the bottom section over the top section also allows the instructions (which are printed on the top section) to be covered over by the bottom section, which displays the device name.

It will he appreciated that, according to one example, the double-fold feature can improve the IS strength and durability of the label. Furthermore, without the triple-section design and double-fold operation, the label may be prone to separate along the bottom edge over time, and is less durable with use and handling.

It will also be appreciated that it is possible to have a double-section label design with a single-fold operation, that is, the third part of the label may not necessarily fold over the instruction panel.

### Feature: Label Design has Allowance for Various Circumferences of Cables, Carabiners and Carry Straps and Various Widths and Thicknesses of Bag Handles

According to this particular example, one part of the top section of the label and one part of the middle section of the label is elongated past the rounded edges of these sections. This area accommodates (i.e. allows for) various cable, carabiner and carry strap circumferences, for example, from 3 mm, up to 20 mm, and for various bag handle widths for example, from 10 mm up to 25 mm, and for various bag handle thicknesses, for example, from 1 mm up to 3 mm.

It will be appreciated that this particular design can make the device for labelling described herein suitable for attachment to all common portable devices, electronic equipment, computer peripheral and network cables in the market (with their various cable circumferences), or to any portable device or item with a carry strap, whilst still retaining its overall look and shape and not affecting any of its other cable label or device label properties. This also allows the same label to be attached to a range of bag handles of various widths and thicknesses, whilst not affecting its overall look and shape and not affecting any of its other bag label properties. Thus, the label can accommodate various cable, carabiner and carry strap circumferences (as is commonly found) and various bag handle widths and thicknesses (as is commonly found). Notably, it is possible to have other label shapes which would provide the same function.

### Feature: The Label is Printed on Synthetic ‘Taper’ (Film)

Synthetic ‘paper’ (film) can be strong, durable, flexible, tear-resistant and water resistant, and typically has a quality feel to the touch. Furthermore, labels manufactured using synthetic ‘paper’ are generally stronger and more durable than labels that use standard paper or plastic-coated paper in their manufacture. Accordingly, a label may be provided which is durable and long-lasting under normal use, and can withstand rough handling and rain as may be typically encountered when travelling.

Thus, according to one particular example, the labels are printed directly onto the synthetic ‘paper’ which is separated from a waxed backing sheet before use, by the user, and has adhesive on the back of the ‘paper’.

It will be appreciated, however, that it is also possible to use other types of materials in the manufacture of labels, such as paper and plastic-coated paper, or different synthetic ‘papers’ which may have varying qualities (i.e. they may or may not be tear-resistant and/or water resistant and may vary in durability).

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1) A device for labelling an item, the device including:
a) A first portion; and,
b) A second portion, the second portion being attached to the first portion, wherein the first portion and the second portion are moveable to a folded position, such that at least a portion of the item is enclosed between the first portion and the second portion, in the folded position.

2) The device of claim 1, wherein a surface of the first portion and a surface of the second portion are attached to each other in the folded position.

3) The device of claim 2, wherein the first portion has an attaching member, the attaching member being configured to attach to the second portion, when in the folded position, to form a second folded position.

4) The device of claim 1, wherein the first portion has a first neck and a first head, the first head being attached to the first neck at one end of the first neck, the first neck being attached to a second neck of the second portion at the other end, the second portion having a second head attached to the second neck, where in the folded position, the first neck and the first head are substantially aligned with the second neck and the second head respectively.

5) The device of claim 4, wherein the first head is attached to the first neck at one end and to an attaching member at the other end, such that, when in the folded position, the attaching member is configured to be foldable over the second head.

6) The device of claim 4, wherein the attaching member adheres to the second head.

7) The device of claim 5, wherein the attaching member is substantially the same shape as the first and second heads.

8) The device of claim 1, wherein the device has an adhesive surface, such that when in the folded position, the first and second portions adhere together and/or encapsulate at least a portion of the item placed between them.

9) The device of claim 5, wherein the second head is a panel including instructions printed thereon for a user of the device, such that when the attaching member folds over the second head, the instructions are at least partially concealed.

10) The device of claim 4, wherein any one or a combination of the first head, the first neck, the second head, and the second neck are panels which are able to receive information.

11) The device of claim 10, wherein the information includes any one or a combination of a user's details, and item details.

12) The device of claim 1, wherein the device is available in a variety of colours, each colour being associated with a user of the item or associated with additional identification details of the item.

13) The device of claim 1, wherein the item includes an elongate portion, the elongate portion being at least partially enclosed between the first and second portions of the device.

14) The device of claim 1, wherein the item is any one or a combination of a cable, a carabiner, a carry strap, a bag handle and/or a shoulder strap.

15) The device of claim 1, wherein the device includes at least one fold line.
